(19) United States
(12) Patent Application Publication
(10) Pub. No.: US 2010/0038128 A1
(43) Pub. Date: Feb. 18, 2010

(54) Cable Capturing Device

(76) Inventor: Steven Ross Johnston, Palm Cove (AU)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/419,903

(22) Filed: Apr. 7, 2009

(30) Foreign Application Priority Data
Apr. 8, 2008 (AU) 2008901682

(51) Int. Cl. H02G 3/08

(52) U.S. Cl. 174/481

(57) ABSTRACT

A device is described to assist electricians capture cabling dropped down through a cavity wall. The device (1) includes an open-ended first hollow cylindrical body (2). A second body (4) is a solid cylindrical tube of a diameter for a sliding fit within the first body (2). A loop of flexible tape-like metal banding (7) has both its free ends (8,9) retained within a slot (6) at an end of the second body (4). On movement of the second body (4), the banding (7) enters the cavity wall to abut the inner rear surface of the cavity, the banding (7) flexing to border a capturing area (29). A cable (23) is then passed down the cavity (22,26) until a suitable length thereof has passed through the capturing area (29). As the second body (4) is then moved away from the wall (20, 25), the cable (23) is retained by the diminishing diameter of the area (29) enabling the cable (23) to readily pass through hole (27,28) to be accessed by the user of the device.

THIS INVENTION relates to a cable capturing device. In particular, it is directed, but not limited, to a device to assist electricians capture cabling dropped down through a cavity wall or the like.

Throughout this specification, unless the contray is expressly stated, where a document, act or item of knowledge is referred to or discussed, this reference or discussion is not an admission that the document, act or item of knowledge or any combination thereof was, at the priority date, publicly available, known to the public, part of the common general knowledge, or known to be relevant to an attempt to solve any problem with which this specification is concerned.

In commercial and residential building construction, cabling is often connected at or near the upper extremities of the construction and then dropped down through a cavity wall to exit through an internal wall of the construction to be connected to a power outlet, telephone point or the like. An electrician has thus first to capture this cable within the wall cavity at the required exit location and then pull the thus-captured cable through a hole in the internal wall. Capturing this cable and then pulling it through the hole is difficult and time-consuming. Usually, a torch is required to illuminate the internal cavity so that the cable can be sighted and then some form of hook is inserted to grasp the cable and pull it through the hole. A disadvantage of a hook is that it does not provide a secure connection to the cable and it may take many attempts to capture and maintain hold of the cable until it passes through the exit location. Further, while a relatively large hole can be easily made, and subsequently repaired, in an internal wall fabricated from plasterboard or similar material, this is not possible if the internal wall is constructed from hollow concrete blocks where only a discrete hole can be made at a location where the hole can be subsequently covered with, for example, the backing plate of an electrical point outlet.

It is thus a general object of the present invention to overcome, or at least ameliorate, one or more of the above-mentioned disadvantages and to provide a cable capturing device for use with varied wall constructions.

According to a first aspect of the present invention, there is provided a device for capturing a cable or similar as it is passed down within a cavity wall or the like to an exit location, said device including:
a first body adapted for releasable attachment at said exit location;
a second body adapted for slidable movement within said first body; and
a capturing means secured to said second body;
wherein said second body can be reversibly moved sufficient to enable said capturing means to capture said cable or similar as it is passed down within said cavity wall and enable withdrawal of thus-captured said cable or similar from said cavity wall at said exit location.

Preferably, said first body is a hollow cylindrical tube.

Preferably, said second body is a substantially solid cylindrical tube of a diameter sufficient for a sliding fit within said hollow cylindrical tube.

Preferably, said second body includes a slot at one end thereof.

Preferably, said capturing means is removably retained in said slot.

Preferably, said capturing means is a closed loop of tape-like material.

Preferably, said tape-like material is metal banding.

In one embodiment of the present invention, said first body is of dimensions sufficient for a friction fit within said exit location

In another embodiment of the present invention, there includes a support body adapted for releasable attachment to said wall or the like at said exit location to which said first body can be releasably attached.

Preferably, said dimensions of, and fixings for, said support body are substantially identical to dimensions and fixings of a backing plate of an electrical point outlet.

As a second aspect of the present invention, there is provided a method for capturing a cable or similar as it is passed down within a cavity wall or the like to an exit location, said method including:
creating an opening at a required said exit location for said cable or similar to pass therethrough;
positioning an assembled said device as hereinbeforedescribed in or over said opening;
moving said second body to a position placing said capturing means within said cavity wall;
passing said cable or similar down said cavity wall until a suitable length of said cable or similar has passed through said capturing means;
sliding said second body within said first body and away from said cavity wall to secure said cable or similar to said capturing means; and
s removing said device from said opening.

Preferred embodiments of the present invention will now be described with reference to the accompanying drawings, wherein:

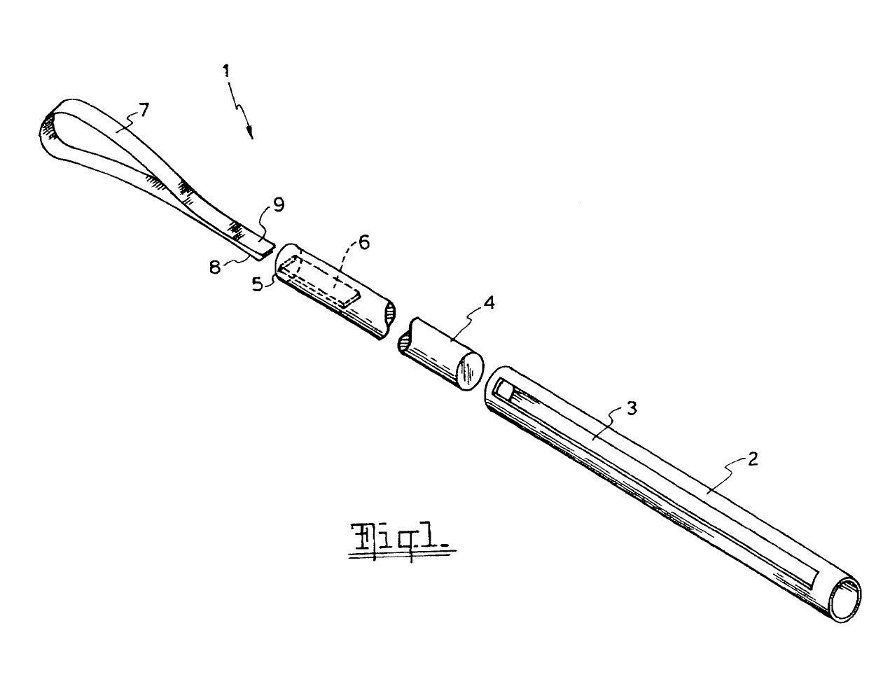

FIG. 1 is an exploded perspective sketch of a device constructed in accordance with the present invention;

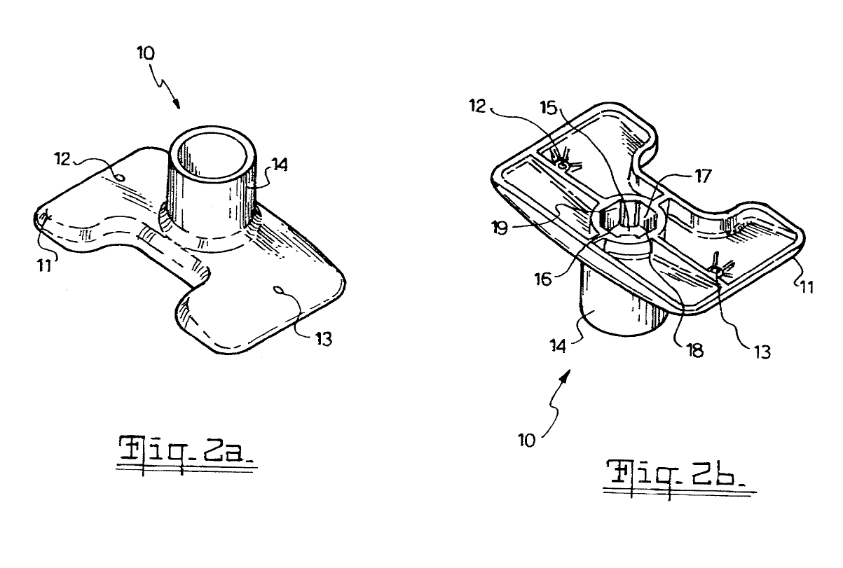

FIG. 2a is an upper perspective sketch and FIG. 2b is a lower perspective sketch of an optional feature for use with the device of FIG. 1;

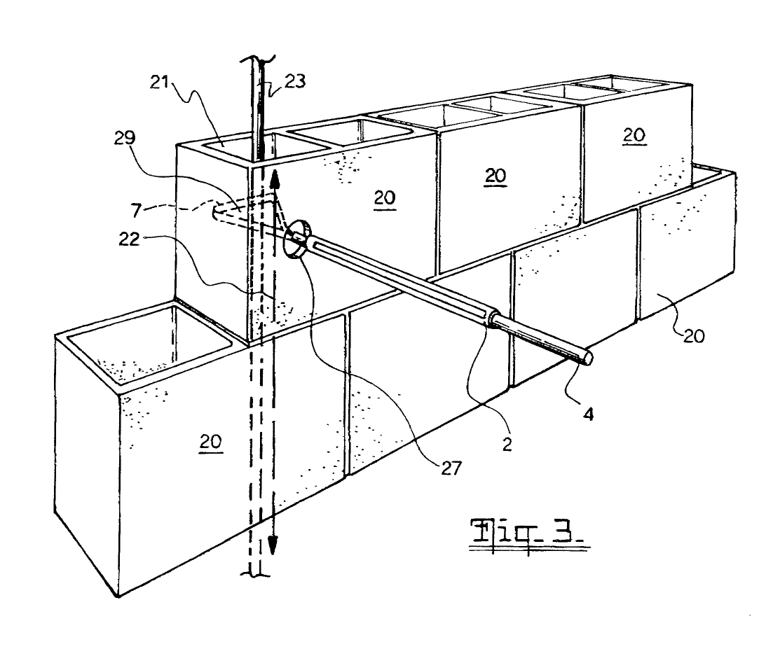

FIG. 3 is a perspective sketch of the device of FIG. 1 attached to the inward facing surface of a concrete block wall; and

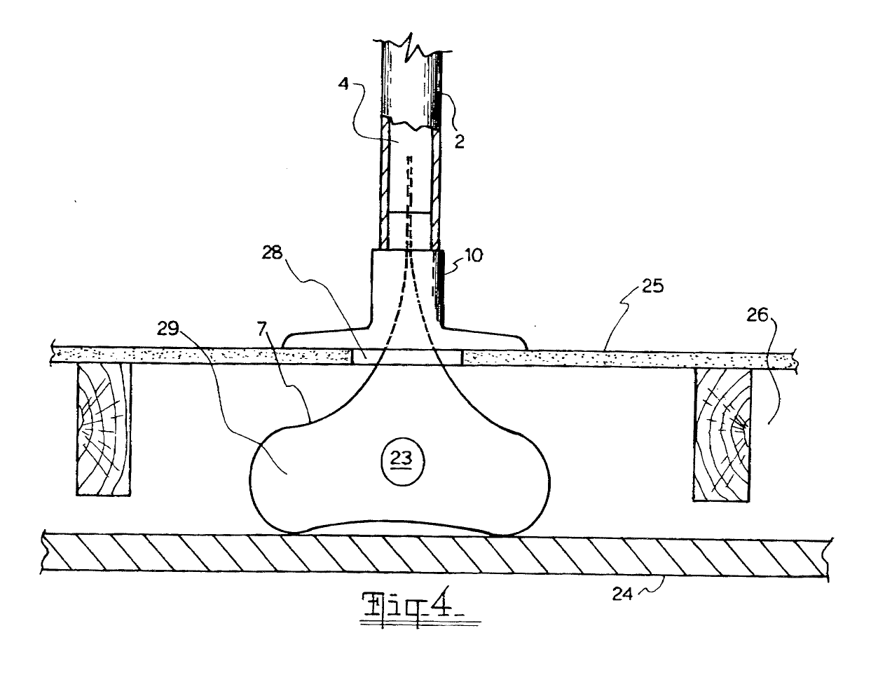

FIG. 4 is a cross-sectional view of the device of FIG. 1 fifted with the feature of FIGS. 2(a,b) affixed to a brick veneer cavity wall.

In these embodiments, like features are referenced by like numerals.

Referring to FIG. 1, the device (1) includes an open-ended first hollow cylindrical body (2). An inspection and/or access slot (3) runs substantially the full length of the body (2). A second body (4) is a substantially solid cylindrical tube of a diameter for a sliding fit within the first body (2). Extending from one end (5) of the body (4) is an internal waved slot (6). A loop of flexible tape-like metal banding (7) has both its free ends (8,9) reversibly retained within the slot (6).

Turning to FIGS. 2(a,b), a support body (10) has a shaped base (11) with a pair of fixing holes (12,13). The spacing between the fixing holes (12,13) is typically equal to the mounting holes of a backing plate for an electrical point outlet. A short hollow extension (14) extends from the base (11). The extension (14) is substantially co-axial with a bore (15) that passes through the base (11) and is of an internal diameter sufficient for the first body (2) to be retained therein as a frictional fit. The inner wall of the bore (15) includes two opposing pairs of recesses (16,17) & (18,19) the width of each being slightly less than the width of the banding (7) (FIG. 1).

With reference to FIGS. 3 & 4, a typical concrete block wall (FIG. 3) is Illustrated where staggered blocks (20) with their overlapping hollow internals (21) create a cavity (22) through which an electrical cable (23) can pass and a typical brick veneer cavity wall is illustrated (FIG. 4) whereby an outer brick wall (24) and an inner plasterboard wall (25) spaced from the brick wall (24) create a cavity (26) through which an electrical cable (23) can pass.

In use, for a concrete block wall (FIG. 3), a hole (27) is drilled in the inward facing surface of a concrete block through to the hollow interior thereof at the required exit location for a cable which is to be connected to an electrical point at that location. The diameter of the hole (27) is sufficient for the first cylindrical body (2) to be held therein as a frictional fit.

For a brick veneer wall (FIG. 4), a hole (28) is drilled in the plasterboard (25) at the required exit location for a cable (23) which is to be connected to an electrical point at that location. The diameter of the hole (28) is at least slightly larger than the width of the banding (7) to allow the banding (7) to be passed freely therethrough. The support body (10) is affixed over this hole (28) using fixing holes (12,13).

The free ends (8,9) of the flexible metal banding (7) are inserted into the slot (6) of the second body (4) and the assembly is then passed through the first body (2). When the banding (7) abuts either the inner rear surface of the concrete block (20) (FIG. 3) or the inner surface of the outer brick wall (24) (FIG. 4), the flexibility of the banding (7) is such that it flexes to border a capturing area (29) which is substantially horizontal within the hollow interior of the concrete block (FIG. 3) or extends between the brick wall (24) and plasterboard wall (25) (FIG. 4).

An electrical cable (23) is then passed down the cavity (22,26) until a suitable length thereof has passed through the capturing area (29). The second body (4) is then moved in a direction away from the wall (20, 25). As the second body (4) is moved, the cable (23) is retained by the diminishing diameter of the area (29) enabling the cable (23) to readily pass through hole (27,28) to be accessed by the user of the device. Once the cable (23) is accessible, the first body (2) and, where appropriate, the support body (10) can be removed. The backing plate of an electrical outlet (not illustrated) can then be mounted on the wall over the hole (27,28).

Although in no way limiting, the first and second bodies (2,4) and the support body (10) can conveniently be manufactured from a plastics material; and the metal banding (7) typically from a spring steel of the type currently used in the manufacture of retractable metal tape measures.

The present invention thus offers a number of advantages which include;
can be used on walls of differing construction;
provides a larger area to readily and easily “capture” the cable;
enables the cable to be held securely while it is being withdrawn from the wall cavity;
minimizes damage to the cavity wall necessary to capture the cable;
is simple in its construction and use; and
is relatively inexpensive to manufacture.

It will be appreciated that the above described embodiments are only exemplifications of the various aspects of the present invention and that modifications and alterations can be made thereto without departing from the inventive concept as defined in the following claims.

1. A device for capturing a cable or similar as it is passed down within a cavity wall or the like to an exit location, said device including:
a first body adapted for releasable attachment at said exit location;
a second body adapted for slidable movement within said first body; and
a capturing means secured to said second body;
wherein said second body can be reversibly moved sufficient to enable said capturing means to capture said cable or similar as it is passed down within said cavity wall and enable withdrawal of thus captured said cable or similar from said cavity wall at said exit location.

2. A device as defined in claim 1 wherein, said first body is a hollow cylindrical tube.

3. A device as defined in claim 2 wherein, said second body is a substantially solid cylindrical tube of a diameter sufficient for a sliding fit within said hollow cylindrical tube.

4. A device as defined in claim 1 wherein, said second body includes a slot at one end thereof.

5. A device as defined in claim 4 wherein said capturing means is removably retained in said slot.

6. A device as defined in claim 1 wherein, said capturing means is a closed loop of tape-like material.

7. A device as defined in claim 6 wherein, said tape-like material is metal banding.

8. A device as defined in claim 1 wherein, said first body is of dimensions sufficient for a friction fit within said exit location.

9. A device as defined in claim 1 which includes a support body adapted for releasable attachment to said wall or the like at said exit location to which said first body can be releasably attached.

10. A device as defined in claim 9 wherein, dimensions of, and fixings for, said support body are substantially identical to dimensions and fixings of a backing plate of an electrical point outlet.

11. A method for capturing a cable or similar as it is passed down within a cavity wall or the like to an exit location, said method including:
creating an opening at a required said exit location for said cable or similar;
positioning an assembled said device as defined in claim 1 in or over said opening;
moving said second body to a first position placing said capturing means within said cavity wall,
passing said cable or similar down said cavity wall until a suitable length of said cable or similar has passed through said capturing means;
sliding said second body within said first body and away from said cavity wall to secure said cable or similar to said capturing means; and
removing said device from said opening.
